(19) United States
(12) Patent Application Publication
(10) Pub. No.: US 2014/0173511 A1
(43) Pub. Date: Jun. 19, 2014

(54) PROCESS AND METHOD FOR INCREASING USAGE FOR A CARPOOLING SYSTEM

(71) Applicants: Jens Lehmann, Sunnyvale, CA (US); David Sommer, Bruehl (DE); Peter Graf, Redwood City, CA (US)

(72) Inventors: Jens Lehmann, Sunnyvale, CA (US); David Sommer, Bruehl (DE); Peter Graf, Redwood City, CA (US)

(21) Appl. No.: 13/714,221

(22) Filed: Dec. 13, 2012

(51) Int. Cl. G06F 3/0484

(52) U.S. Cl. CPC G06F 3/04842
USPC 715/810

(57) ABSTRACT

A backend carpooling system including a memory device, a processing device, a communication device, a calculating arrangement, coupled to the memory and processing devices, that includes one or more algorithms for calculating distances, travel times, routes, and performing optimizations to select a distance, travel time, or route satisfying predetermined optimization criteria, the calculating arrangement generating a plurality of ridesharing opportunities, and a notification arrangement, coupled to the communication device, that transmits the plurality of ridesharing opportunities to a user, wherein the plurality of ridesharing opportunities are periodically transmitted to the user.

### BACKGROUND

Automated carpooling systems match potential drivers with one or more passengers who are seeking rides. In existing carpooling systems, potential drivers and passengers submit messages, notifications, or other entries to the carpooling system. These entries may include a starting or pickup location, an ending or dropoff location, a date/time range during which the traveling may occur, a passenger capacity of the driver's vehicle, and a maximum travel time the driver is willing to accept during carpooling.

FIG. 1 illustrates an example road map depicting a hypothetical carpooling scenario for a plurality of users.

As shown in FIG. 1, example road map 100 includes a highway, represented by the two parallel lines, and an assortment of streets, represented by the single lines. The map 100 also depicts the starting location of a carpool driver 110, five passengers 141 to 145, and an office 150, which may be the final destination for all of the participants 110 and 141 to 145 in this example.

Existing carpooling systems use optimization algorithms to match drivers and passengers. However, the success of a carpooling solution is directly related to the number of people using it. As the number of drivers, passengers, and vehicle capacities increase, the number of users who can rely on the carpooling service also increases. A reliable carpooling solution should achieve a “critical mass” of users to ensure that users have a high hit rate when searching for ride sharing opportunities. If the critical mass is not achieved, people who try the service without success will no longer try the service and, at most, become passive users. If the number of active users declines, the service becomes less effective as a means for providing ride sharing opportunities.

Accordingly, there is a need for large scale carpooling systems that attract and retain a critical mass of users. Accordingly, the embodiments of the present invention are directed to a method and system to increase the number of active users of a carpooling system.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an example road map depicting a hypothetical carpooling scenario for a plurality of users;

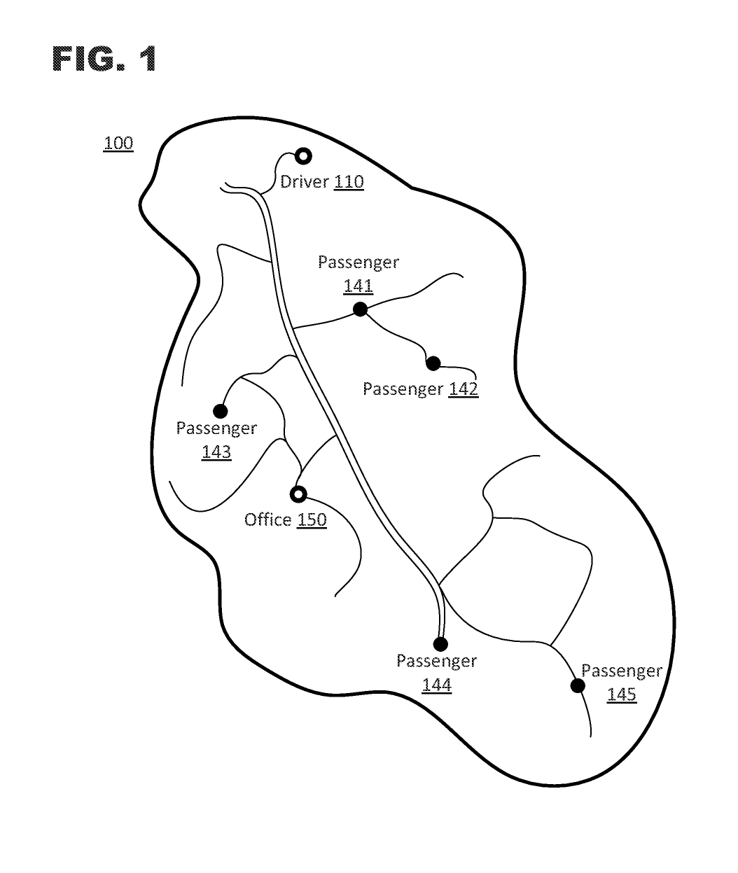

FIG. 2 illustrates a method for promoting the use of a carpooling system according to an example embodiment of the present invention;

FIG. 3 illustrates a system level architecture having interaction between a remote electronic device and a backend carpooling system according to an example embodiment of the present invention;

FIG. 4 illustrates a representative architecture of a carpooling backend server according to an example embodiment of the present invention; and

FIG. 5 illustrates a representative architecture of a portable electronic device according to an example embodiment of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, that may include one or more other physical user-interface devices, such as a keyboard and or mouse.

The portable communication device may support a variety of applications, such as telephone, text messenger, word processor, and carpooling applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, a carpooling system is used as an example embodiment, but it should be understood that the user interfaces and associated methods may be applied to other applications.

A carpooling system that actively notifies passive users about ridesharing opportunities is provided. For example, the backend of the carpooling system may notify users of possible rides based on their home location stores within a backend server in the system. Alternatively, the backend of the carpooling system may notify users based on other locations, such as a place of employment or a location provided by a user or GPS of a user's portable electronic device. Even non-active users (e.g., no ridesharing in previous days, no intent to rideshare the next week) still receive a notification (e.g., e-mail, short message service (SMS), or the like) listing available opportunities.

For example, a user of the carpooling application can periodically receive a limited number of carpool alerts (e.g., one notification per day). Notifications can be triggered by a scheduler within backend system (e.g., daily at 12 PM, 1 PM, etc.) or by an event (e.g., a baseball game) that can generate numerous new ride intents associated with the event.

In some embodiments, the carpooling application may alert users about “fake” carpool opportunities. Instead of triggering the notifications about potential carpools via an actual ride intent by another user, we trigger the notification at a predefined time (e.g., 7 am-8 am to work and 5 pm-6 pm home from work) via an administrator defined probability (e.g., for 50% of all users, or other method) to generate interest in the carpooling application so that potential users may submit an actual ride intent.

Ridesharing opportunities can be provided according to one or more criteria. For example, opportunities can be provided to passive users living along a well traveled corridor having an existing ride request in the system. The destination end of the ridesharing opportunity can be a point of interest to the user, such as a place of employment, or a general point of interest, such as an airport. In suggesting possible ridesharing opportunities, the distance to the route, or the distance between the origin and destination can also be considered. In addition, a user can also request, within a preferences menu, to be notified of opportunities within a certain distance of his home or other location. Alternatively, a user may desire to be notified of ridesharing opportunities between certain times.

The carpooling system may present a user with a list of carpooling options and the user may manually select one of the carpooling options. After reviewing possible ridesharing opportunities, users can respond by selecting one of the rides. For example, a user can be supplied with a link to affirm the user's ride intent corresponding to a suggested ridesharing opportunity. Thereafter, changes may be submitted if a user or other participant is no longer able to participate in the scheduled carpool. For example, a carpool participant may get sick or have a meeting rescheduled and therefore may need to cancel and/or reschedule a carpool.

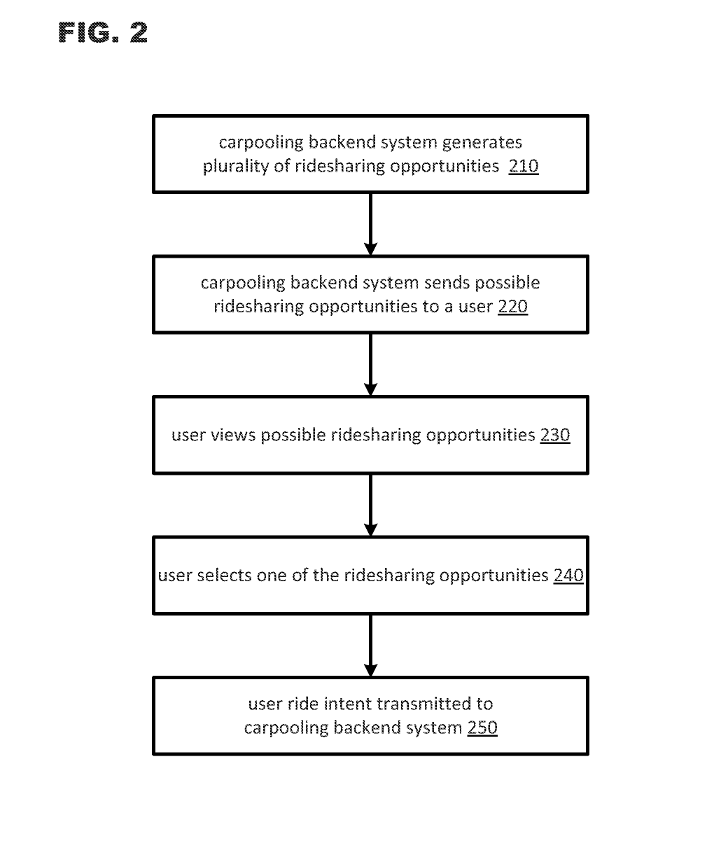

FIG. 2 illustrates a method for promoting the use of a carpooling system according to an example embodiment of the present invention.

At step 1, a carpooling backend system generates plurality of ridesharing opportunities. As described below, a carpooling backend system, such as a carpooling server, generates ridesharing options based on user data. For example, a potential driver may transmit several types of information to the backend system including maximum travel time and final destination. Similarly, a prospective passenger may transmit several types of information to the backend system including final destination and time windows for traveling. In yet another alternative, location information of a user may be supplied by a GPS module of a mobile phone or other electronic device.

Modules within the carpooling backend system can supply requested routes, location information, and other user information to one or more algorithms to calculate distances, travel times, routes, and perform optimizations to identify more efficient routes that comply with user criteria.

In some instances, drivers may be assigned to passengers according to an optimization that may minimize the total travel time for a driver. For example, a total travel time for the driver to pick up and drop off each passenger designated as eligible for carpooling with the driver may be calculated. The driver may be then be assigned to the eligible passenger that results in a lowest calculated total travel time.

An estimated time the driver will arrive at a final destination after picking up and dropping off each passenger designated as eligible for carpooling with the driver may also be calculated for each identified passenger seeking a carpool assignment. If the calculated estimated time the driver will arrive at the final destination occurs after a desired arrival time of the carpool driver, then each of those passengers may be designated as ineligible for carpooling with the driver.

At step 2, the carpooling backend system transmits the possible ridesharing opportunities to one or more users. Active and non-active users alike can receive a notification via e-mail, short message service (SMS), or the like, listing available opportunities.

The backend system can periodically send carpool alerts to users. These notifications can be triggered by a scheduler within backend system. Alternatively, notification can be triggered by an event, such as a sports game, that can generate numerous new ride intents associated with the event. In yet another alternative, a user may query the carpooling application for ridesharing options that satisfy the user's criteria, such as pick-up and drop-off times and locations.

Next, at step 3, a user views possible ridesharing opportunities. After the backend system transmits ridesharing opportunities, an alert can present a user with a list of carpooling options.

At step 4, the user may manually select one of the carpooling options. After reviewing possible ridesharing opportunities, users can respond by selecting one of the rides. For example, a link to accept a ride can be provided with each ridesharing opportunity. A user can simply select the supplied link to accept a ridesharing opportunity.

In some instances, after carpool passengers and drivers have been assigned to respective carpools, one or more of the participants in the carpool may decide that the carpool assignment is no longer suitable and they may cancel their participation in the carpool. The cancellation may also be part of a request to reschedule a carpool time. Participants may cancel and/or reschedule the assigned carpools for a variety of reasons, including illness, change of plans, inclement weather, and so on.

Lastly, at step 5, the user ride intent is transmitted to carpooling backend system. At this step, the driver and other passengers associated with the selected ridesharing option can be notified of the additional passenger.

In some instances, the carpooling backend system may alert users about “fake” ridesharing options. For example, a fake ridesharing notification may identify carpooling opportunities at a predefined time based on user information (e.g., 7 am-8 am to work and/or 5 pm-6 pm to home). Fake notifications may be used simply to generate user interest in carpooling and may prompt a potential user to submit an actual ride intent. Of course, if a user selects a fake ridesharing opportunity, it may appear as full or canceled, thus prompting the user to submit an actual ride intent.

The above process may be used in one-way or multi-segment carpools. Multi-segment carpools may include round-trip carpools or multiple destination carpools. In the case of round-trip or multiple destination carpools, the process may be configured to preserve ride continuity, so that either the entire round-trip or each of the multiple destinations are able to be completed or the entire trip is cancelled. This feature, when used, may prevent stranding of carpool passengers. For example, if a passenger is initially assigned to a first carpool to get to work from home at the beginning of a shift and then a second carpool to get from work to home at the end of a shift, then a cancellation or rescheduling of the second carpool that prevents the passenger from participating in the second carpool may cause the system to cancel both the first and the second carpools for that passenger if another suitable carpool can not be found for the passenger. This may prevent the passenger from getting stranded at work at the end of the shift due to the lack of a ride home.

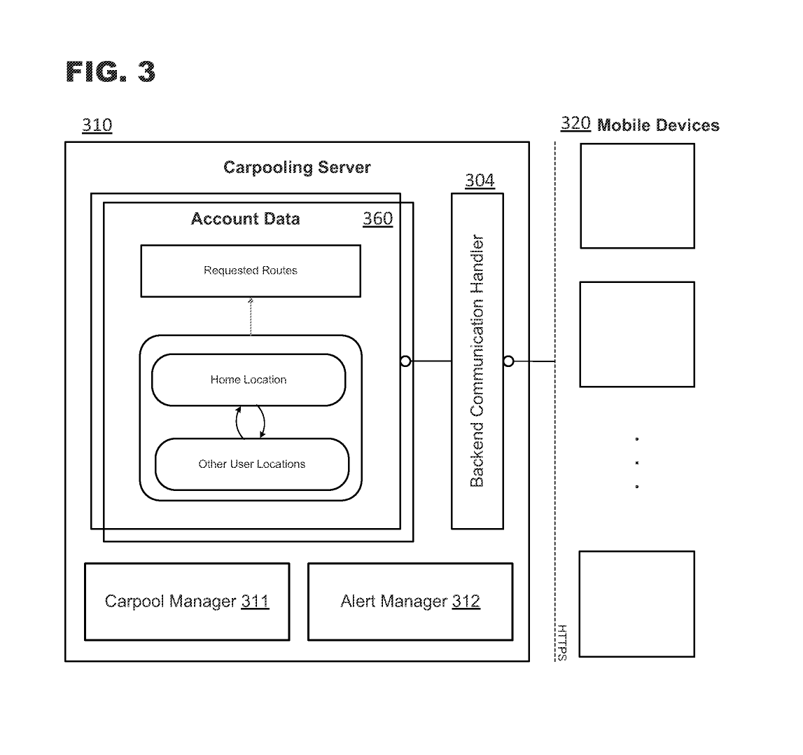

FIG. 3 illustrates a system level architecture that depicts the interaction between a remote electronic device and a backend carpooling system according to an example embodiment of the present invention.

As shown in FIG. 3, the system level architecture includes a carpooling server 310 that is connected to one or more remote electronic devices 320. The carpooling server 310 can be connected to remote electronic devices 320 using known or expected network technologies, such as wireless local area networks (WLAN), wireless wide area networks (WWAN), and Internet, some examples of which include WiFi, long term evolution (LTE), and the like. Backend communication handler 312 manages communications functions for the carpooling server 10. Similarly, each remote electronic device is also equipped with means for communication with a network, such as an antenna coupled to communication circuitry.

Carpooling server 320 includes one or more account database 360 that stores several types of information that can be supplied by the remote electronic devices 320. For example, account database 360 can store user location information, such as home location and work locations, as well as carpooling routes requested by a user.

In addition, carpooling server 310 may include a carpool manager 311 to generate one or more carpooling opportunities be supplied to remote electronic devices 320. The carpool manager 311 can utilize requested routes and location information stored in account database 360 to generated suggested carpools. The calculating manager 311 may include one or more algorithms for calculating distances, travel times, routes, and performing optimizations to select a distance, travel time, or route satisfying predetermined optimization criteria. The algorithms may also include algorithms to identify each possible permutation of routes between multiple geographic locations, and to identify and/or designate those route permutations having the shortest distances.

The carpooling server 310 may include alert manager 312 to generates user notifications indicating possible ridesharing opportunities. The alert manager 312 can be coupled to communication device 304 to transmit alerts via e-mail, short message service (SMS), and the like.

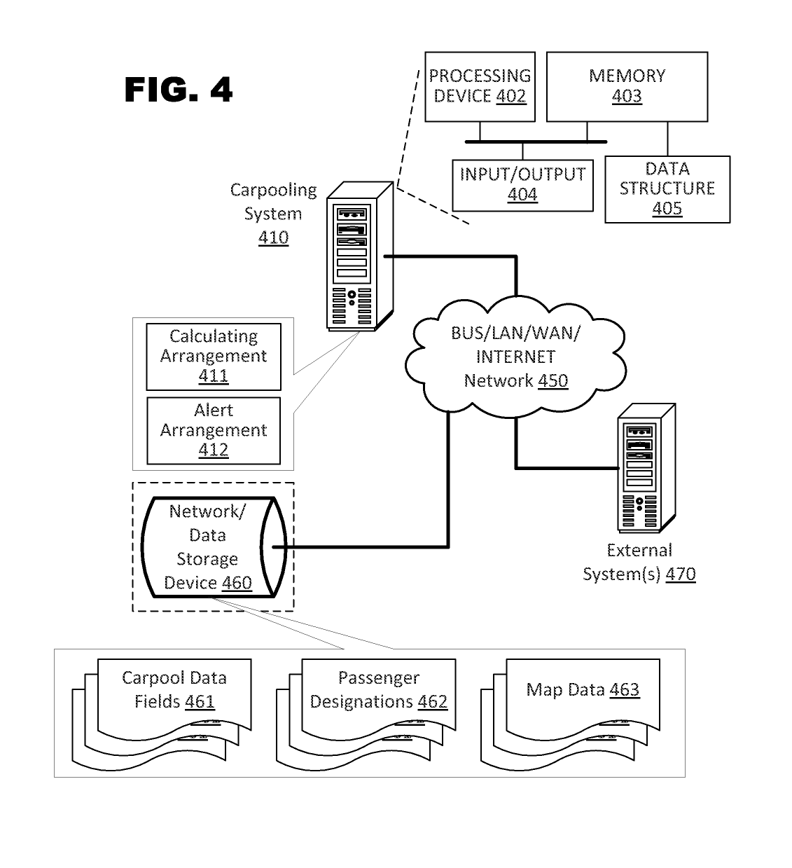

FIG. 4 illustrates a representative architecture of a carpooling backend server portable electronic device according to an example embodiment of the present invention.

The calculating arrangement 411 may include one or more algorithms for calculating distances, travel times, routes, and performing optimizations to select a distance, travel time, or route satisfying predetermined optimization criteria. The algorithms may also identify each possible permutation of routes between multiple geographic locations, and to identify and/or designate those route permutations having the shortest distances. The calculating arrangement 411 may also include or use a processing device 402 to apply the algorithms to a set of data inputs and a calculate the result.

The notification arrangement 412 generates alerts to be transmitted to active and non-active users alike. The notification arrangement 412 can be coupled to communication device 404 to transmit alerts via e-mail, short message service (SMS), and the like.

Carpooling system 410 may be connected to a network 450. Network 450 may include a LAN, WAN, bus, or the Internet. Carpooling system 410 may interface with other systems and components depending on the application. For example, a network/data storage device 460 may be used to store the different types of data structures, including carpool data fields 461, which may include data fields representing a starting location of the carpool driver, an ending location of the carpool driver, a maximum travel time of the carpool driver, and a passenger capacity of the carpool driver's vehicle; passenger designation fields 462, which may indicate whether a passenger is eligible, ineligible, approved, and/or assigned to carpool with a particular carpool driver; and map data 463, which may store geographic base map data that may be used to identify routes and calculate distances.

The storage device 460 may be a part of the carpooling system 410. In some embodiments the network storage device 460 may also be separate from the carpooling system 410 but connected to it through network 450. The storage device 460 may contain a hard disk drive, flash memory, or other computer readable media capable of storing data. Other external systems and data sources 470 may also be connected to network 450. These other systems 470 may be used to supply additional data or information used by the carpooling system 410, such as, for example, new data from new passengers and new drivers willing to carpool, or updates, cancellations, or changes from existing passengers and drivers.

Each of the systems, clients, and devices in FIG. 4 may contain a processing device 402, memory 403 storing loaded data or a loaded data structure 405, and an communications device 404, all of which may be interconnected via a system bus. In various embodiments, each of the systems 410, 460, and 470 may have an architecture with modular hardware and/or software systems that include additional and/or different systems communicating through one or more networks. In addition, the carpooling system can be a stand alone system or integrated with other enterprise software and hardware. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

Communications device 404 may enable connectivity between the processing devices 402 in each of the systems and the network 450 by encoding data to be sent from the processing device 402 to another system over the network 450 and decoding data received from another system over the network 450 for the processing device 402.

In an embodiment, memory 403 may contain different components for retrieving, presenting, changing, and saving data. Memory 403 may include a variety of memory devices, for example, Dynamic Random Access Memory (DRAM), Static RAM (SRAM), flash memory, cache memory, and other memory devices. Additionally, for example, memory 403 and processing device(s) 402 may be distributed across several different computers that collectively comprise a system.

Processing device 402 may perform computation and control functions of a system and comprises a suitable central processing unit (CPU). Processing device 402 may include a single integrated circuit, such as a microprocessing device, or may include any suitable number of integrated circuit devices and/or circuit boards working in cooperation to accomplish the functions of a processing device. Processing device 402 may execute computer programs, such as object-oriented computer programs, within memory 403.

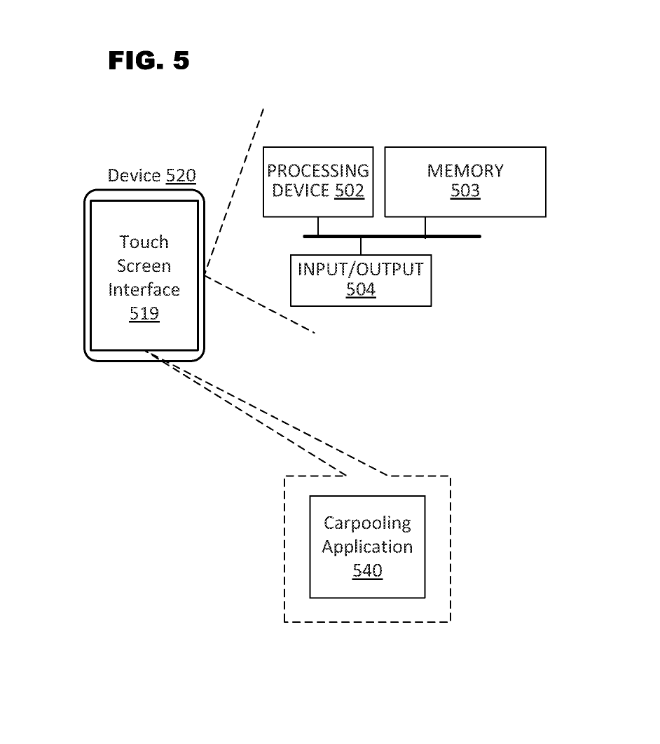

FIG. 5 illustrates a representative architecture of a portable electronic device according to an example embodiment of the present invention.

A portable electronic device 520 may include a touch screen interface 519, processing device 502, memory 503, communications interface 504. The touch screen interface 519 may include a display, which may be a touch screen, capable of displaying data to a user of the portable electronic device 520.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor.

Portable electronic device 520 may also include a locally stored and executed carpooling application 540 that that generally implements the local functionality of the carpooling system. For example, the carpooling application 540 may transmit user ride requests to the backend system. In addition, the carpooling application may display possible ride sharing opportunities to a user. Carpooling application 540 may also include a visualization module (not shown) to enable the display features of the carpooling application.

Memory 503 may include a computer readable medium storing application modules, which may include instructions associated with applications and modules of the portable electronic device 520.

The device 520 may contain a processing device 502, memory 503, and a communications device 504, all of which may be interconnected via a system bus. In various embodiments, the device 520 may have an architecture with modular hardware and/or software systems that include additional and/or different systems communicating through one or more networks via communications device 504.

Communications device 504 may enable connectivity between the processing devices 502 in the portable electronic device 520 and other systems by encoding data to be sent from the processing device 502 to another system over a network and decoding data received from another system over the network for the processing device 502.

In an embodiment, memory 503 may contain different components for retrieving, presenting, changing, and saving data and may include computer readable media. Memory 503 may include a variety of memory devices, for example, Dynamic Random Access Memory (DRAM), Static RAM (SRAM), flash memory, cache memory, and other memory devices. Additionally, for example, memory 503 and processing device(s) 502 may be distributed across several different computers that collectively comprise a system. Memory 503 may be capable of storing user inputs and preferences.

Processing device 502 may perform computation and control functions of a system and comprises a suitable central processing unit (CPU). Processing device 502 may include a single integrated circuit, such as a microprocessing device, or may include any suitable number of integrated circuit devices and/or circuit boards working in cooperation to accomplish the functions of a processing device. Processing device 502 may execute computer programs, such as object-oriented computer programs, within memory 503.

The foregoing description has been presented for purposes of illustration and description. It is not exhaustive and does not limit embodiments of the invention to the precise forms disclosed. It will be apparent to those skilled in the art that various modifications and variations can be made in the process and method for increasing usage for a carpooling system of the present invention without departing from the spirit or scope of the invention. Thus, it is intended that the present invention cover the modifications and variations of this invention provided they come within the scope of the appended claims and their equivalents.

We claim:

1. A method for increasing usage of a carpooling system, the method comprising:
generating a plurality of ridesharing opportunities;
transmitting the plurality of ride sharing opportunities to a user; and
receiving, from the user, a selection of one or more of the plurality ridesharing opportunities.

2. The method according to claim 1, further comprising periodically transmitting the plurality of ridesharing opportunities.

3. The method according to claim 1, further comprising providing a link to the user to indicate selection of one or more of the plurality ridesharing opportunities.

4. The method according to claim 1, wherein the plurality of ridesharing opportunities are based on a home location of the user.

5. The method according to claim 1, wherein the plurality of ridesharing opportunities are based a common point of interest or an event that the user will attend.

6. The method according to claim 1, wherein one of the plurality of ridesharing opportunities is a fake ridesharing opportunity.

7. A backend carpooling system comprising:
a processing device;
a communication device coupled to the processing device;
a calculating arrangement, coupled to the processing device, that includes one or more algorithms to calculating distance, travel times, routes, and performing optimizations to select a distance, travel time, or route satisfying user criteria, the calculating arrangement to generate a plurality of ridesharing opportunities; and
a notification arrangement, coupled to the communication device, to transmit the plurality of ridesharing opportunities to a user.

8. The system according to claim 7, wherein the notification arrangement periodically transmits an updated plurality of ridesharing opportunities.

9. The system according to claim 7, wherein the user is provided with a link to indicate selection of one or more of the plurality ridesharing opportunities.

10. The system according to claim 7, wherein the plurality of ridesharing opportunities are based on a home location of the user.

11. The system according to claim 7, wherein the plurality of ridesharing opportunities are based a common point of interest or an event that the user will attend.

12. The system according to claim 7, wherein one of the plurality of ridesharing opportunities is a fake ridesharing opportunity.

13. A computer readable medium for increasing usage of a carpooling system, the computer readable medium processing instructions for:
generating a plurality of ridesharing opportunities;
transmitting the plurality of ridesharing opportunities to a user; and
receiving, from the user, a selection of one or more of the plurality ridesharing opportunities.

14. The computer readable medium according to claim 13, further comprising periodically transmitting the plurality of ridesharing opportunities.

15. The computer readable medium according to claim 13, further comprising providing a link to the user to indicate selection of one or more of the plurality ridesharing opportunities.

16. The computer readable medium according to claim 13, wherein the plurality of ridesharing opportunities are based on a home location of the user.

17. The computer readable medium according to claim 13, wherein the plurality of ridesharing opportunities are based a common point of interest or an event that the user will attend.

18. The computer readable medium according to claim 13, wherein one of the plurality of ridesharing opportunities is a fake ridesharing opportunity.

19. A backend carpooling system comprising:
a processing device;
a communication device coupled to the processing device;
a memory device that stores user criteria including user location information and user requested routes for a plurality of users;
a calculating arrangement, coupled to the memory and processing devices, that includes one or more algorithms for calculating distances, travel times, routes, and performing optimizations to select a distance, travel time, or route satisfying the user criteria stored in the memory, the calculating arrangement generating a plurality of ridesharing opportunities, and
a notification arrangement, coupled to the communication device, to transmit the plurality of ridesharing opportunities to a user.
